(19) United States
(12) Patent Application Publication
(10) Pub. No.: US 2014/0048454 A1
(43) Pub. Date: Feb. 20, 2014

(54) COLLECTORS FOR ORE BENEFICIATION

(71) Applicant: CECA S.A., La Garenne Colombes (FR)

(72) Inventors: Isabelle Birken, Serezin Du Rhone (FR); Mathieu Spinnhirny, Lyon (FR)

(73) Assignee: CECA S.A., LA GARENNE COLOMBES (FR)

(21) Appl. No.: 13/967,907

(22) Filed: Aug. 15, 2013

Related U.S. Application Data
(60) Provisional application No. 61/684,954, filed on Aug. 20, 2012.

(30) Foreign Application Priority Data
Aug. 20, 2012 (FR) 12.57882

(51) Int. Cl. B03D 1/01; B03D 1/02

(52) U.S. Cl. CPC B03D 1/01; B03D 1/02
USPC 209/166; 564/224; 252/61

(57) ABSTRACT

The present invention relates to fatty amido amine collectors for the beneficiation by flotation of aqueous suspensions of ores, the use of said fatty amido-amine collectors in flotation processes for the beneficiation of ores, more particularly in reverse flotation processes for the beneficiation of silicates containing-ores.

### CROSS REFERENCE TO RELATED APPLICATIONS

This application claims priority of U.S. Provisional Patent Application Ser. No. 61/684,954, filed Aug. 20, 2012, and claims priority to French Patent Application No. 12.57882, filed Aug. 20, 2012, the contents of such applications being incorporated by reference herein.

### BACKGROUND OF THE INVENTION

The present invention relates to the use of cationic collectors in flotation processes for the beneficiation of ores, more particularly in reverse flotation processes for the beneficiation of ores, particularly of ore-containing silicates.

Flotation consists in extracting minerals out of a suspension, generally an aqueous suspension, of an ore, by rendering more hydrophobic (less wettable by water) the particles to be floated, using specific reagents, usually referred to as collectors by the skilled artisans. Direct flotation process refers to the case where the floated particles are the ores of value, whereas reverse flotation process refers to the case where the floated particles are the impurities to be extracted out of the ores of value.

Flotation process generally takes place in a cell containing an aqueous suspension of the ore to be treated, and a generator of air bubbles. At least one collector is added and the at least one collector adsorbs onto the surface of the particles of minerals or impurities to be removed, enhancing the attachment of the particles with air bubbles upon collision. The combined air bubbles/particles, less dense than the pulp, go up to the surface, leading to the formation of a froth that can be collected either by skimming or via an overflow.

Mineral flotation such as flotation of silica, silicates, feldspath, mica, clays, potash and other minerals, which bear a negative charge at the pH value where the flotation is operated, is typically achieved by using cationic collectors. Cationic collectors are molecules that are at least partly positively charged when added in an aqueous environment at an appropriate pH value.

Hence, the term “cationic collectors” is herein understood to represent organic collector compounds containing at least one amino group. Such cationic collectors are already known and widely used and include for example fatty amines and their salts, fatty propylene polyamines and their salts, alkyl ether amines and alkyl ether diamines and their salts, quaternary ammonium salts, imidazoline derivatives, alkoxylated amines, and the like.

More precisely, in the seventies, a combination of N-tallow-trimethylenediamine diacetate (Duomac® T from Akzo Nobel, CAS RN 61791-54-6) and a tertiary amine having one fatty alkyl group and two polyoxyethylene groups attached to nitrogen (Ethomeen 18/60, 50 ethylene oxide adducts from Akzo Nobel, CAS RN 99241-69-7) have been used to remove micaceous schist, pyrite and quartz from calcite rock. These collectors however present the disadvantage to be solid, and need be dissolved in warm water prior using.

In order to obviate this problem, U.S. Pat. No. 3,990,966 proposed the use of a flotation reagent chosen from among 1-hydroxyethyl-2-heptadecenyl glyoxalidine, 1-hydroxyethyl-2-alkylimidazolines and salt derivatives thereof, for the removal of impurities from calcite.

For separating silica from other minerals such as iron ore or phosphates, ether amines and ether diamines and their salts are mentioned in U.S. Pat. No. 4,319,987. These amines and diamines are mostly used in their partially neutralized forms, as acetates. The reason for this is the better solubility of the partially neutralized amine function.

U.S. Pat. No. 5,261,539 proposed alkoxylated C₈-C₂₄ alkyl guanidines containing 1-10 alkoxy groups, alkoxylated C₈-C₂₄ alkyl fatty amines containing 1-6 alkoxy groups and mixtures thereof, as cationic collectors to remove quartz, micaceous minerals, chlorite, pyrite and other mineral impurities from finely ground calcium carbonate. This patent discloses higher calcium carbonate recoveries compared to Alkazene®, an imidazoline-type collector.

U.S. Pat. No. 4,995,965 claims a mixture containing at least one compound from the group comprising hydroxyl propylated quaternary ammonium compound, unsymmetrical dialkyl dimethyl quaternary ammonium compounds and dialkyl hexahydro pyrimidine. Similarly, U.S. Pat. No. 5,540,337 claims acrylonitrile free-ether amines flotation material.

International application WO 1994/026419 describes the combination of quaternary ammonium salts with an adduct of alkylene oxide and amine compound, for which the sum of all alkylene oxide groups is 10 to 40. This combination achieves an improvement in calcium carbonate beneficiation; leading to a very high yield and/or a high selectivity, as compared to prior art, for example U.S. Pat. No. 4,995,965.

Another international application, WO 2007/122148, describes the combination of at least two collectors, belonging to fatty quaternary ammonium salts or fatty bis-imidazoline quaternary ammonium compounds, and more preferentially a combination of two quaternary ammonium salts for the reverse froth flotation of calcite ore.

WO2008/084391 specifically claims a process of purification of calcium carbonate using as a collector agent at least one compound which is a quaternary imidazolium methosulphate, more particularly. 1-methyl-2-noroleyl-3-oleic acid-aminoethyl imidazolium methyl sulphate.

Even more recently, US patent application 2009/0152174 claims a mixture of alkyl etheramine, alkyl etherdiamine, alkylamine or quaternary ammonium salt with fatty triamine corresponding to the formula R—N-[A-NH₂]₂, for use as an improved collector for silicate flotation. Examples are given for silicates reverse flotation in calcite. The most efficient mixture pointed out in the examples is a mixture of 29% of fatty triamine with 71% of the standard quaternary ammonium salt (dicoco alkyl dimethylammonium chloride).

One common feature of all the known beneficiation processes is that collectors, which are inherently attached to the floated particles, remain in the tailings. It is known that most of amines and amine derivatives have aquatic and environmental toxicity. In order to lessen the environmental impact, studies have been conducted to improve the performances of flotation reagents, thereby leading to a lower dosage of the flotation reagents used.

From the prior art, the skilled artisan is clearly taught that efficient collectors for silicate flotation, especially in calcium carbonate ores, have been developed during the last years, these efficient collectors mostly being mixtures of cationic reagents containing at least one cationic molecule permanently charged (at least one quaternary nitrogen atom in the molecule).

Beside lowering the dosage of such aminated collectors, another way to improve the situation regarding environmental issues would be to use more environment friendly cationic molecules, i.e. less toxic and/or biodegradable flotation reagents.

German patent application DE 196 02 856 proposes the use of biodegradable quaternary ammonium esters, e.g. esterquats. According to WO 2007/122148 (see above), such esterquats were found to degrade by hydrolysis and/or through biological pathway during the flotation step.

However this piece of prior art teaches that, in the calcite reverse froth flotation process, fatty acids resulting from this degradation attach to the calcite and floats the mineral as well, resulting in poor yield.

There is therefore a continuous need to optimize or find alternatives for the reverse froth flotation of silicates, for example in calcium carbonate ore beneficiation.

In the case of calcium carbonate, the efficiency of the flotation step is evaluated by measuring the yield of the product, that should be as high as possible (low calcite losses in the froth), and the amount of acid insoluble materials in the products (remaining silicates) that should be as low as possible.

A first objective of the present invention consists in providing an efficient reagent for the froth flotation of mineral ores, which is environmental friendly, i.e. less toxic and/or more biodegradable than collectors already known in the art.

Another objective of the present invention consists in providing an efficient reagent (or collector) for the froth flotation of mineral ores, which is environmental friendly, i.e. less toxic and/or more biodegradable than collectors already known in the art, and which provides satisfactory beneficiation yields. Other objectives will appear from the following description of the present invention.

It has now been found that the above objectives are met in whole or at least in part when froth flotation is conducted with the herein-below described flotation reagent, the use of which being the also an object of the present invention.

It has indeed been found that particularly good results are obtained when the collector comprises at least one of the following compounds of formula (1).

### DETAILED DESCRIPTION OF THE INVENTION

According to a first aspect, the present invention deals with a collector for the beneficiation by flotation of an aqueous suspension of minerals, said collector comprising at least one compound of formula (1):

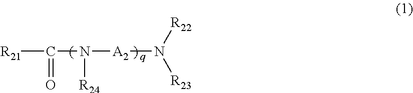

wherein
R₂₁ represents a hydrocarbon group containing from 6 to 30 carbon atoms,
R₂₂ and R₂₃ which are identical or different, each independently represent a hydrocarbon group containing from 1 to 6 carbon atoms,
R₂₄ represents hydrogen or a hydrocarbon group containing from 1 to 6 carbon atoms,
A₂ represents an alkylene group having from 1 to 6 carbon atoms, and
q is 1, 2, 3 or 4.

Mixtures of compounds of formula (1) having various R₂₁ radicals are encompassed within the present invention, for example, mixtures of compounds of formula (1) wherein the various R₂₁ radicals contain from 16 to 18 carbon atoms.

In formula (1) above, R₂₁ is a straight, cyclic or branched, saturated or unsaturated hydrocarbon group, preferably a straight or branched, unsaturated hydrocarbon group having from 6 to 30, preferably from 8 to 26, more preferably from 12 to 22 carbon atoms, said group optionally containing one or more rings.

Compounds of formula (1) may also be used in the form of their addition salts with one or more acid(s), said acid(s) being chosen from among mineral and organic acids, including but not limited to, hydrochloric acid, acetic acid, phosphoric acid, sulphuric acid, alkane (e.g. methane) sulphonic acid, toluene sulphonic acid, and the like.

Preferred compounds of formula (1) are those having one or more of the following characteristics:
R₂₂ and R₂₃ which are identical or different, each independently represent a hydrocarbon group containing from 1 to 6 carbon atoms, preferably from 1 to 4 carbon atoms, and preferably are chosen from among methyl, ethyl, propyl and butyl,
R₂₂ and R₂₃ are identical,
R₂₄ represents hydrogen,
A₂ represents an alkylene group having from 1, 2, 3 or 4 carbon atoms, preferably A₂ is ethylene or propylene, more preferably A₂ is propylene, and
q is 1 or 2, preferably q is 1.

Compounds of formula (1) are commercially available or may be prepared according to known preparations techniques.

For example, compounds of formula (1) may be easily obtained by condensation of an unsaturated fatty acid (rapeseed oil, tall oil) with an amine compound of formula (1′):

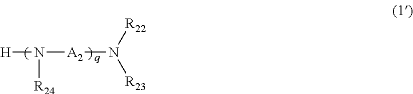

wherein R₂₂, R₂₃, R₂₄, A₂ and q are as defined above.

The condensation product of dimethyl amino propyl amine with a C₁₆-C₁₈ unsaturated fatty acid, such as from rapeseed oil (CAS RN 85408-42-0), or from tall oil (CAS RN 68650-79-3) are of particular interest as they are liquid at room temperature (easy to handle), readily dispersible in water, i.e. not needing to be totally or partially salified, at the dosage level used in flotation process (typically from 10 ppm to 1000 ppm), and present the further advantage of being biodegradable.

Other examples of compounds of formula (1) are the condensation products of dimethyl amino propyl amine with a coco, palm, tallow, and/or oleic fatty acid, and/or with a C₁₂ (e.g. lauric) fatty acid, and/or with a C₁₁ (e.g. ricinoleic) fatty acid, and/or with C₂₀-C₂₂ fatty acid, and/or the like. Other examples of compounds formula (1) are those with the following Registry CAS numbers: 68188-30-7, 69278-64-4, 691400-76-7, 165586-99-2, 226994-25-8, 97552-95-9 which are the condensation products of dimethyl amino propyl amine with soya oil, castor oil, peanut oil, almond oil, avocado oil, fish oil, respectively.

The collector of the present invention, for beneficiation by flotation of aqueous suspensions of ores, may consist in one or more compounds of formula (1) as defined above, alone. Alternatively, one or more of the compounds of formula (1) may advantageously be formulated with any conventional additive(s) known in the art of flotation.

Non limitative examples of such additives are pH-adjusting agents, such as sodium or potassium carbonate and sodium or potassium hydroxide; solvents (water, organic solvent(s) and mixtures thereof); depressants, such as starch, quebracho, tannin, dextrin and guar gum, and polyelectrolytes, such as polyphosphates and water glass, which have a dispersant effect, often combined with a depressant effect. Other conventional additives are frothers (foaming agents), such as methyl isobutyl carbinol, triethoxybutane, pine oil, terpineol and polypropylene oxide and its alkyl ethers, among which methyl isobutyl carbinol, triethoxy butane, pine oil, terpineol, are preferred frothers. By way of non limiting examples, such conventional additives are generally frothers, among which terpineol is the most commonly used.

According to a further preferred embodiment, the compound(s) of formula (1) may also advantageously be formulated with one or more other conventional collector compounds known in the art of flotation, more preferably cationic collectors, “cationic collectors” having the meaning given above. Preferred such conventional cationic collectors are those containing no sulphur atoms, and most preferred are those containing carbon, nitrogen and hydrogen atoms only, and optionally oxygen atoms. Said conventional cationic collectors, in the form of their addition salts with acids, may however contain sulphur atom(s), when the salifying acid itself comprises sulphur atom(s), e.g. sulphuric, sulphonic or alkane sulphonic acid.

Example of conventional cationic collectors that may be used with collectors of formula (1) include, but are not limited to:
fatty amines and their salts, as well as their alkoxylated derivatives,
fatty poly(alkylene amines) and their salts, e.g. poly(ethylene amines), poly(propylene amines) and their salts, as well as their alkoxylated derivatives,
fatty amidopolyamines, and their salts, as well as their alkoxylated derivatives,
fatty amidopoly(alkylenamines), and their salts, as well as their alkoxylated derivatives,
fatty imidazolines and their salts, as well as their alkoxylated derivatives,
N-fatty alkyl amino carboxylic acid and their salts, e.g. N-fatty alkyl amino propionic acid and their salts,
alkyl ether amines and alkyl ether diamines and their salts,
quaternary ammonium compounds, e.g. fatty quaternary ammonium compounds, mono(fatty alkyl) quaternary ammonium compounds, di(fatty alkyl) quaternary ammonium compounds, such as those described in WO 2007/122148,
and the like.

In the description of the present invention, “polyamine” intends a compound comprising two or more amine groups, the amine groups possibly being substituted, i.e. the two or more amine groups may be identical or different and be primary, secondary or tertiary amine groups.

Specific examples of cationic compounds that may be used together with compound of formula (1) as a collector according to the present invention, include, without any limitation, dicoco-dimethyl ammonium chloride (CAS RN 61789-77-3), coco-dimethylbenzyl ammonium chloride (CAS RN 61789-71-7), tallow dimethyl benzyl ammonium chloride (CAS RN 61789-75-1), ethoxylated tallow monoamine, 1,3-propanediamine-N-tallow diacetate (CAS RN 68911-78-4), N,N′,N′-tri-hydroxy-ethyl N-tallow propylene diamine (CAS RN 61790-85-0), N,N′,N′-tri-hydroxyethyl N-oleyl propylene diamine (CAS RN 103625-43-0), N,N′,N′-tri-hydroxyethyl N-lauryl propylene diamine (CAS RN 25725-44-4), fatty alkyl imidazoline obtained by condensation of diethylenetriamine and oleic fatty acid (CAS RN 162774-14-3), N,N′,N′-tri-hydroxyethyl N-behenyl-propylene diamine (CAS RN 91001-82-0), isodecyloxypropyl-1,3-diaminopropane (CAS RN 72162-46-0), N,N-di(tallow carboxyethyl)-N-hydroxyethyl-N-methyl ammonium methylsulphate (CAS RN 91995-81-2), N-coco-β-aminopropionic acid (CAS RN 84812-94-2), N-lauryl-β-aminopropionic acid (CAS RN 1462-54-0), N-myristyl-β-aminopropionic acid (CAS RN 14960-08-8), their addition salts with acid(s), sodium salt of N-lauryl-β-aminopropionic acid (CAS RN 3546-96-1), triethanolamine salt of N-lauryl-β-aminopropionic acid (CAS RN 14171-00-7), triethanolamine salt of N-myristyl-β-aminopropionic acid (CAS RN 61791-98-8), as well as mixtures of two or more of the above compounds, in all proportions, and the like.

According to another preferred embodiment, the collector of the present invention comprises from 1 wt % to 100 wt % of at least one compound of formula (1), more preferably from 10% wt 100 wt %, typically from 20 wt % to 100 wt % of at least one compound of formula (1), advantageously from 1 wt % to 99 wt % of at least one compound of formula (1), more preferably from 10% wt to 99 wt %, typically from 20 wt % to 99 wt % of at least one compound of formula (1) relative to the total amount of compound(s) of formula (1) and other cationic compounds.

According to a particularly advantageous embodiment of the present invention, the collector according to the present invention comprises, and preferably consists in, at least one compound of formula (1) as herein-before described, and at least one compound of formula (2):

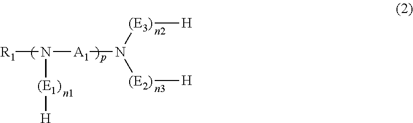

wherein
R₁ represents a hydrocarbon group containing from 6 to 30 carbon atoms,
A₁ represents an alkylene group having from 1 to 6 carbon atoms,
E₁, E₂ and E₃, identical or different from each other, are independently chosen from among alkylene oxide groups having from 1 to 6 carbon atoms,
n₁, n₂ and n₃, identical or different from each other, and independently from each other, each represent an integer which value is from 1 to 20, and
p is 1, 2, 3 or 4.

Compounds of formula (2) may also be used in the form of their addition salts with one or more acid(s), said acid(s) being chosen from among mineral and organic acids, including, but not limited to, hydrochloric acid, acetic acid, phosphoric acid, sulphuric acid, alcane (e.g. methane) sulphonic acid, toluene sulphonic acid, and the like.

According to a preferred aspect of the present invention, the collector of the present invention comprises at least one compound of formula (1) as herein-above defined, optionally together with at least one compound of formula (2) above, and is substantially free, more preferably is free, from any quaternary ammonium-containing compound.

Mixtures of compounds of formula (2) having various R₁ radicals are encompassed within the present invention, for example, mixtures of compounds of formula (2) wherein the various R₁ radicals contain from 16 to 18 carbon atoms.

In the here-above formula (2), and according to a preferred embodiment, R₁ is a straight, cyclic or branched, saturated or unsaturated hydrocarbon group having from 6 to 30, preferably from 8 to 26, more preferably from 12 to 22 carbon atoms, said group optionally containing one or more rings.

According to another embodiment, preferred compounds of formula (2) are those wherein A₁ represents an alkylene group having from 1 to 6 carbon atoms, preferably from 2 to 6 carbon atoms, more preferably from 2, 3 or 4 carbon atoms. Preferred compounds of formula (2) are those wherein A₁ represents propylene.

Still according to another preferred embodiment, E₁, E₂ and E₃ are chosen from methylene oxide —(CH₂—O)—, ethylene oxide —(CH₂—CH₂—O)—, propylene oxide —(CH₂—CH(CH₃)—O)— and/or —(CH(CH₃)—CH₂—O)—, and butylene oxide —(CH(CH₂—CH₃)— CH₂—O)— and/or —(CH₂—CH(CH₂—CH₃)—O)—, it being understood that E₁, E₂ and E₃ are linked to the respective nitrogen atom via their sp₂ carbon atom. Preferably E₁, E₂ and E₃ are chosen from ethylene oxide —(CH₂—CH₂—O)—, and propylene oxide —(CH₂—CH(CH₃)—O)— and/or —(CH(CH₃)—CH₂—O)—. More preferably from 70 mol % to 100 mol % of all the alkylene oxide groups present in the compound of formula (1), are ethylene oxide groups and 0 mol % to 30 mol % are propylene oxide groups. Still more preferably E₁, E₂ and E₃ are identical radicals and are chosen from among ethylene oxide and propylene oxide, even more preferably all E₁, E₂ and E₃ are identical radicals and are ethylene oxide groups. It should also be understood that each of E₁, E₂ and E₃ may comprise two or more different alkylene oxides groups that may be arranged in block or random distribution.

According to a first alternative, compounds of formula (2) are those wherein n₁, n₂ and n₃, which are identical or different, independently represent an integer which value is from 3 to 20, preferably from 3 to 10. Preference is also given to compounds of formula (2) wherein the sum n₁+n₂+n3 ranges form 10 to 40, preferably from 10 to 30.

According to another alternative, compounds of formula (2) are those wherein n₁, n₂ and n₃, which are identical or different, independently represent an integer which value is from 1 to 10, more preferably from 1 to 5, still more preferably from 1 to 3. Preference is also given to compounds of formula (2) wherein the sum n₁+n₂+n₃ is strictly less than 10.

In the above-described compounds of formula (2), p is preferably 1 or 2, more preferably p is 1.

According to a preferred embodiment, the above compound of formula (2) possess one or several of the following characteristics:
R₁ represents a straight or branched hydrocarbon group containing from 6 to 30 carbon atoms, preferably from 8 to 26, more preferably from 12 to 22 carbon atoms, optionally containing one or more insaturation(s), in the form of double and/or triple bond(s),
A₁ represents a straight or branched alkylene group having from 1 to 6 carbon atoms, preferably from 2 to 6 carbon atoms, more preferably 2, 3 or 4 carbon atoms,
E₁, E₂ and E₃, identical or different from each other, are independently chosen from among ethylene oxide (OE) group, propylene oxide (OP) group and butylene oxide (OB) group, preferably among OE group and OP group, more preferably each of E₁, E₂ and E₃ represents an OE group,
n₁, n₂ and n₃, which identical or different, independently represent an integer which value is from 1 to 20, preferably from 1 to 10, and the sum n₁+n₂+n₃ ranges from 3 to 40, preferably from 3 to 30,
p is 1, 2, 3 or 4, preferably 1 or 2, more preferably p is 1.

According to a further preferred embodiment, the above compound of formula (2) possess one or several of the following characteristics:
R₁ represents a straight alkyl group containing from 8 to 26, more preferably from 12 to 22 carbon atoms,
A₁ represents a straight alkylene group having from 2 to 4 carbon atoms, for example a —(CH₂)₃-(propylene) group,
E₁, E₂ and E₃, identical or different from each other, are independently chosen from among OE group and OP group, more preferably each of E₁, E₂ and E₃ represents an OE group,
n₁, n₂ and n₃, which are identical or different, independently represent an integer which value is from 1 to 5, preferably from 1 to 3 and the sum n₁+n₂+n₃ ranges from 3 to 9, for example the sum n₁+n₂+n₃ is 3,
p is 1 or 2, and is preferably 1.

According to still a further preferred embodiment, the above compound of formula (2) possess one or several of the following characteristics:
R₁ represents a straight alkyl group containing from 8 to 26, more preferably from 12 to 22 carbon atoms,
A₁ represents a straight alkylene group having from 2 to 4 carbon atoms, for example a —(CH₂)₃-(propylene) group,
E₁, E₂ and E₃, identical or different from each other, are independently chosen from among OE group and OP group, more preferably each of E₁, E₂ and E₃ represents an OE group,
n₁, n₂ and n₃, which are identical or different, independently represent an integer which value is from 3 to 20, preferably from 3 to 10. Preference is also given to compounds of formula (2) wherein the sum n₁+n₂+n3 ranges form 10 to 40, preferably from 10 to 30.
p is 1 or 2, and is preferably 1.

More advantageously, the compounds of formula (2) are chosen from among alkoxylated C₆-C₃₀ alkyl fatty polyamines, even more advantageously C₆-C₃₀ alkyl ethoxylated or propoxylated fatty diamines.

The compounds of formula (2) are commercially available or may be prepared according to known preparations techniques.

For example, compounds of formula (2) may be easily obtained by condensation of a fatty polyamine with an alkylene oxide. A typical example of a compound of formula (2) is an ethoxylated tallow diamine, for example a tallow diamine reacted with one or more molecules of ethylene oxide, for example N′,N′,N′-tri-hydroxyethyl-N-tallow propylene diamine (tallow diamine with 3 moles ethylene oxide), having Registry CAS number 61790-85-0.

This compound is of particular interest as it is liquid at room temperature, easy to handle, readily dispersible in water, i.e. no need to be partially or totally salified, at the dosage level used in flotation process (typically from 10 ppm to 1000 ppm). Moreover this product is biodegradable.

As other compounds of formula (2), that can advantageously be used together with at least one compound of formula (1) as defined above, in the collector according to the present invention, mention may be made of various alkoxylated propylene diamine compounds for example N,N′,N′-tri-hydroxyethyl-N-oleyl propylene diamine (CAS Registry Number 103625-43-0), N,N′,N′-tri-hydroxyethyl-N-lauryl propylene diamine (CAS RN 25725-44-4), propoxylated N-tallow-alkyltrimethylenediamines (CAS RN 68603-75-8), and the like.

The collector according to the present invention thus preferably comprises, and more preferably consists in:
at least one compound of formula (1) as defined above;
optionally at least one compound of formula (2) as defined above;
optionally at least one other conventional collector, preferably conventional cationic collector;
optionally one or more additive(s) conventionally used in the art, and for example chosen from among pH-adjusting agents, depressants, polyelectrolytes, frothers and the like.

More specifically, the collector according to the present invention preferably comprises, and more preferably consists in:
at least one compound of formula (1) as defined above;
at least one compound of formula (2) as defined above;
optionally at least one other conventional collector, preferably conventional cationic collector;
optionally one or more additive(s) conventionally used in the art, and for example chosen from among pH-adjusting agents, depressants, polyelectrolytes, frothers and the like.

Still more specifically, the collector according to the present invention preferably comprises, and more preferably consists in:
one compound of formula (1) as defined above;
at least one compound of formula (2) as defined above;
optionally at least one other conventional collector, preferably conventional cationic collector;
optionally one or more additive(s) conventionally used in the art, and for example chosen from among pH-adjusting agents, solvents, depressants, polyelectrolytes, frothers and the like.

Even more specifically, the collector according to the present invention preferably comprises, and more preferably consists in:
one compound of formula (1) as defined above;
one compound of formula (2) as defined above;
optionally at least one other conventional collector, preferably conventional cationic collector;
optionally one or more additive(s) conventionally used in the art, and for example chosen from among pH-adjusting agents, depressants, polyelectrolytes, frothers and the like.

For example, the collector according to the present invention comprises, and preferably consists in:
one compound of formula (1) as defined above;
one compound of formula (2) as defined above.

The weight ratio of compound(s) of formula (1) to compound(s) of formula (2) in the collector of the present invention may vary in great proportions, without any specific limitation. According to a preferred embodiment, this weight ratio ranges from 1:99 to 99:1, more preferably from 20:80 to 80:20, even more preferably from 40:60 to 60:40. Particularly satisfactory results are obtained with a 50:50 weight ratio mixture of at least one compound of formula (1) and at least one compound of formula (2), and typically with a 50:50 weight ratio mixture of compound(s) of formula (1) to compound(s) of formula (2).

Therefore and according to a second aspect, the present invention deals with the use of at least one collector, and preferably one collector, as previously defined, for the beneficiation by direct or reverse, preferably reverse, flotation of an aqueous suspension of ores containing minerals.

The collector of the present invention is efficient either in direct flotation processes or in reverse flotation processes. The collector of the present invention is particularly adapted for the beneficiation of aqueous suspensions of ores using a reverse flotation process.

The use of the present invention is particularly efficient for the beneficiation of all types of impurities containing-ores, and more precisely for the beneficiation of carbonates (calcium and/or magnesium carbonates), phosphates and iron ores, the beneficiation of calcium carbonates being particularly preferred.

The use of the present invention is particularly appropriate for the beneficiation of all types of calcium carbonates (natural or ground), such as limestone, chalk, marble, calcite, calcium carbonate-containing materials (70% minimum content of CaCO₃), alkaline earth metal containing calcium carbonates (e.g. sodium calcium carbonate or gaylussit), magnesium carbonates (e.g. magnesium carbonate containing calcium carbonates, such as dolomite), beryllium carbonates, strontium carbonates, barium carbonates, radium carbonates, as well as mixtures thereof.

“Natural calcium carbonate” in the meaning of the present invention is a calcium carbonate (calcite) obtained from natural sources, such as marble, limestone, or chalk. “Ground calcium carbonate” (GCC) in the meaning of the present invention is a natural calcium carbonate that is processed through a wet and/or dry treatment such as grinding, screening and/or fractionating, for example by a cyclone or classifier.

Other ores that can be efficiently beneficiated using the collectors according to the present invention include wollastonite, barite, titanium oxides (e.g. rutile, anatase, brookite), kaolin, kaolinitic clays (soft white clays composed mainly of kaolinite), calcined kaolinitic clays, montmorillonite, sepiolite, talc, diatomaceous earths, aluminium oxides (e.g. α-Al₂O₃, γ-Al₂O₃), aluminium oxides containing other elements, such as sodium (e.g. diaoyudaoite), as well as other oxides, sulphates and sulphides, such as zinc oxides, zirconium dioxides, tin dioxide, lead carbonate, barium sulphate, and zinc sulphide, including mixtures of two or more of the foregoing in all proportions.

The above mentioned ores are often defined as “white pigments”. In the meaning of the present invention, a white pigment is a pigment that has a white colour. The white colour of the white pigments is predominately based on the relatively low light absorption in combination with an unselective light scattering of the visual light at the pigments. The white pigments in the present invention are inorganic white pigments that may be naturally or synthetically obtained.

The collectors according to the present are also efficient for the direct or reverse froth flotation of “non-white pigments” (as opposed to the above-listed white pigments). Non-white pigments include, however not being limited to, ores chosen from among phosphates, potassium chloride, metal-containing ores, wherein “metal” stands for e.g. iron, platinum, aluminium, nickel, copper, and the like.

The minerals that are efficiently eliminated, or at least the content of which in the ores is significantly reduced by flotation, may be of any type known by the skilled in the art, and preferably provided they are negatively charged at the pH where the flotation is operated. Generally speaking said impurities (or minerals) include, but are not limited to, insoluble graphite, iron sulphides (e.g. pyrite, marcasite, magnetopyrite, pyrrhotite, mackinawite), iron oxides (e.g. wüstite, magnetite), iron hydroxides and iron oxyhydroxides (e.g. bernalite, goethite, lepidocrocite, feroxyhyte, ferrihydrite, schwertmannite, akaganeite), silica, silicates (neosilicates, sorosilicates, cyclosilicates, inosilicates, phyllosilicates, tectosilicates and/or amorphous silicates, such as zircon, willemite, olivine, mullite, forsterite, aluminosilicates, fayalite, ilavite, gehlenite, epidote, kornerupine, benitonite, beryl, tourmaline, enstatite, wollastonite, rhodenite, diopside, amphibolite, grunerite, cummingtonite, actinolithe, hornblende, talc, kaoline, kaolinitic clay, calcined kaolinitic clay, halloysite, dickite, vermiculite, nontronite, sepiolite or montmorillonite, mica minerals, biotite, muscovite, phiogopite, lepidolite or glauconite, clinochlore, quartz, tridymite, cristobalite, feldspar minerals, diatomaceous earth or opale), mica, clays, potash (potassium chloride), and the like, as well as mixtures thereof. Preferably the minerals that are efficiently eliminated, or at least the content of which in the ores is significantly reduced, by direct or reverse, preferably reverse, froth flotation of ores, include silicates, preferably quartz minerals, such as quartz, tridymite an/or cristobalite, more preferably quartz, as well as mixtures of quartz and one or more additional silicates, even more preferably quartz alone.

The use of the present invention is particularly well adapted for the beneficiation of calcium carbonate, and typically where the minerals (impurities) that are efficiently eliminated comprise silicates, preferably quartz.

When one or more compounds of formula (1) are used with one or more other compounds as defined above, for example those of formula (2), they may be added separately, but are preferably added together as a single flotation reagent (collector).

The total content of the each of compound(s) of formula (1) and of compound(s) of formula (2), which may represent the total amount, by weight, of the collector according to the invention, for use in the beneficiation process by flotation of an aqueous suspension of ores according to the present invention, may vary within wide limits depending on the nature of the ores to be purified and the nature and amount of the impurities contained therein. Generally the total amount of collector ranges of from 10 ppm to 5000 ppm by weight, preferably from 50 ppm to 1000 ppm, for example from 200 ppm to 500 ppm relative to the amount of ore(s) to be beneficiated.

The use according to the invention, of a collector comprising one or more compounds of formula (1) for the reverse flotation in the beneficiation of ores leads to at least partially biodegradable, non toxic or at least only weakly toxic, floated impurities (tailings). This represents a real improvement as compared to the known collectors of the prior art. Such tailings, comprising floated impurities, preferably silicates, and at least one compound of formula (1), form a further object of the present invention.

The invention is further illustrated by the following examples, which show the performance of collectors in reverse flotation of silicates in calcium carbonates ores.

### EXAMPLES

Laboratory flotation experiments are carried out using an Outotec flotation cell, filled with 2 L of water. 800 g of calcium carbonate are added in order to obtain a 30 wt % slurry. The sample of calcium carbonate used for the experiment contains between 2.5 wt % and 3 wt % of impurities. Flotation experiment takes place at neutral pH.

The flotation reagent (collector) is weighed and directly added into the flotation cell. The amount introduced is expressed as ppm by weight relative to the initial CaCO₃ amount introduced into the slurry. The slurry is stirred for 5 minutes (conditioning time) at 1200 rpm without air bubbles, followed by 20 to 30 minutes maximum of flotation. Finally air is bubbled into the slurry, the air flow rate being set to 3 L.mn⁻¹.

The purified carbonate sample is filtrated, weighed after drying and analyzed: Hydrochloric acid (HCl) attack is followed by a second drying and weighting in order to measure the amount of acidic insoluble compounds (remaining silicates). The HCl attack aims at obtaining a complete dissolution of calcium carbonate by an appropriate dissolution with concentrated hydrochloric acid solution (typically 10%). The remaining minerals that are not digested correspond to the silicates (impurities).

The froth is also rinsed and filtrated. It is then dried, weighed, submitted to an HCl attack, dried and weighed again in order to deduce the amount of impurities and the calcium carbonate losses.

Products used :

The following collectors are used:
Collector A (Comparative)=Dicoco, dimethyl ammonium chloride, CAS RN 61789-77-3, 75 wt % in isopropanol (15 wt %) and water (10 wt %);
Collector B (Comparative)=Coco, dimethylbenzyl ammonium chloride CAS RN 61789-71-7, 50 wt % in water;
Collector C (Comparative)=mixture of
   82 wt % of collector A,
   6 wt % of ethoxylated tallow monoamine (CAS RN 61791-26-2 obtained by ethoxylation of tallow fatty amine with 20 ethylene oxide moles per mole of amine);
   12 wt % of 1,3-propanediamine-N-tallow diacetate, CAS RN 6891-78-4, diluted at 36 wt % in a mixture 50/50 wt % of water and 2-butoxy ethanol (CAS RN 111-76-2);
Collector D (general formula (2))=N,N′,N′-tri-hydroxyethyl N-tallow propylene diamine, CAS RN 61790-85-0;
Collector E (according to the invention, general formula (1))=rapeseed-oil, N-(3-(dimethyl amino)propyl))amide, CAS RN 85408-42-0;
Collector F (general formula (2))=N,N′,N′-tri-hydroxyethyl N-oleyl propylene diamine, CAS RN 103625-43-0;
Collector G (general formula (2))=N,N′,N′-tri-hydroxyethyl N-coco propylene diamine, CAS RN 25725-44-4;
Collector H (general formula (2))=ethoxylated N-tallow alkyl, trimethylene diamine (CAS RN 61790-85-0), obtained by ethoxylation of N-tallow 1,3-propylenediamine with 7 moles of ethylene oxide per mole of diamine;
Collector I (general formula (2))=mixture of ethoxylated N-arachidyl- and N-behenyl-propylene diamine, obtained by ethoxylation of a mixture of N-arachidyl-, and N-behenyl-1,3-propylene diamine with 7 moles of ethylene oxide per mole of diamine;
Collector J (comparative)=ethoxylated N-tallow alkyl, propylene diamine, (CAS RN 61790-85-0), obtained by ethoxylation of N-tallow 1,3-propylene diamine with 12 moles ethylene oxide per mole of diamine;
Collector K (according to the invention, general formula (1))=tall-oil, N-(3-(dimethyl amino)propyl))amide (CAS RN 68650-79-3);
Collector L (according to the invention, general formula (1))=fish oil, N-(3-(dimethyl amino)propyl))amide, (CAS RN 97552-95-9);
Collector M (according to the invention, general formula (1))=coco, N-(3-(dimethyl amino)propyl))amide, (CAS RN 1335203-24-1);
Collector N (comparative)=isodecyloxypropyl-1,3-diaminopropane (CAS RN 72162-46-0);
Collector O (comparative)=mixture of 10 wt % of propane-2-ol and 90 wt % of N,N-di(tallow carboxyethyl)-N-hydroxyethyl-N-methyl ammonium methylsulphate;
Collector P (comparative)=mixture of:
   38 wt % of collector A;
   56 wt % of a collector which is a mixture of 75 wt % of hydrogenated tallow dimethyl benzyl ammonium chloride (CAS RN 61789-75-1) in 15 wt % propane-2-ol and 10 wt % water;
   6 wt % of a 50/50 wt % mixture of Hydrosol® A200 and 2-ethylhexanol (CAS RN 104-76-7).

### Calcium Carbonate Beneficiation Tests

Flotation of calcium carbonate is operated as described above, using the above-mentioned collectors A, C, D and E, at various concentrations. The results are shown on Table 1 below.

TABLE 1

| | Dosage mg | Calcite | Acid insoluble = |
|---|---|---|---|
| | of collector/kg | Loss in the froth | remaining impurity |
| Collector | of CaCO₃ | (wt %) | amount (wt %) |
| A | 800 | 3.75 | 0.08 |
| A | 500 | Not enough foaming | — |
| C | 500 | 2.67 | 0.11 |
| D | 500 | 3.22 | 0.11 |
| E | 500 | 1.84 | 0.49 |

These results clearly show that collectors D and E, although they do not contain any quaternary ammonium group, show very good results compared to the standard collector A, a quaternary ammonium salt (Dicoco, dimethyl ammonium chloride), that is commonly used for this type of flotation. It is possible to carry out the flotation at 500 ppm with a mixture of collectors D and E, whereas at this dosage the foaming properties of collector A are not satisfactory enough to obtain an industrial appropriate collection of impurities.

Collectors D and E do not require any partial salification prior using, contrary to the commercial ether amine and ether diamine collectors.

Results obtained with collector E at 500 ppm, in terms of loss of calcite in the froth, are better than a formulation of standard collector C which is a mixture of quaternary ammonium salt, diamine diacetate and highly ethoxylated fatty monoamine. Collector E is biodegradable, whereas formulation C contains product with poor biodegradability.

The results given in Table 2 below show the influence of the quantity of collector used:

TABLE 2

| | Dosage | Calcite: | Acid insoluble = |
|---|---|---|---|
| | mg of collector/ | Loss in the froth | remaining impurity |
| Collector | kg of CaCO₃ | (wt %) | amount (wt %) |
| A | 800 | 3.75 | 0.08 |
| C | 500 | 2.67 | 0.11 |
| C | 300 | not enough foaming | — |
| E | 500 | 1.84 | 0.49 |
| E | 300 | 1.51 | 1.32 |

This example shows that collector E is still active, at 300 ppm, whereas at this same dosage, the flotation could not take place with collector C: not enough foaming.

The results presented in Table 3 below allow for the comparison of the efficiency of various collectors, containing one component or mixtures of components, and provide comparative data for mixtures of components D and E, depending on their weight ratio.

TABLE 3

| | Dosage | | Acid insoluble = |
|---|---|---|---|
| | mg of | Calcite: | remaining |
| | collector/ | Loss in the | impurity |
| Collector | kg of CaCO₃ | froth (wt %) | amount (wt %) |
| A | 800 | 3.75 | 0.08 |
| C | 500 | 2.67 | 0.11 |
| D | 500 | 3.22 | 0.11 |
| D | 300 | 2.71 | 0.70 |
| E | 500 | 1.84 | 0.49 |
| E | 300 | 1.51 | 1.32 |
| 50 wt % D + 50 wt % E | 500 | 2.97 | 0.08 |
| 25 wt % D + 75 wt % E | 300 | 1.91 | 0.82 |
| 50 wt % D + 50 wt % E | 300 | 1.89 | 0.56 |
| 75 wt % D + 25 wt % E | 300 | 2.23 | 0.7 |

At a dosage of 500 ppm, compared to collector E, collector D leads to a very low amount of remaining impurities (acid insoluble of 0.11 wt %). Collector D however seems less selective (higher CaCO₃ losses). Using a mixture of collectors D and E leads to a lower amount of impurities (0.08% instead of 0.11%) while maintaining calcium carbonate losses at a reasonable level (<3%). The use of compound of formula (2) according to the invention provides for even better results when combined/associated with a compound of formula (1). Both collectors D and E are biodegradable.

It is still possible to carry out flotation at dosage of 300 ppm with collectors

D and E. Better results are achieved for blends, especially the 50/50 and 75/25 wt % blends of D and E, compared to both collectors used alone: CaCO₃ losses are lower when mixtures are used, as compared to D alone, impurities level are lower for the mixtures, as compared to E alone.

The results shown in Table 4 below illustrate the use of conventional additives (typically a foamer) with a collector according to the invention.

TABLE 4

| | Dosage: | | Acid insoluble = |
|---|---|---|---|
| | mg of | Calcite: | remaining |
| | collector/ | Loss in the froth | impurity |
| Collector | kg of CaCO₃ | (wt %) | amount (wt %) |
| 50 wt % D + 50 wt | 500 | 2.97 | 0.08 |
| % E | | | |
| 50 wt % D + 50 wt | 300 | 1.89 | 0.56 |
| % E | | | |
| 45 wt % D + 45 wt | 300 | 2.54 | 0.20 |
| % E + 10% | | | |
| terpineol | | | |

This example clearly shows that the collector of the present invention (mixture of 50 wt % D+50 wt % E) can advantageously be formulated with well known conventional additives, such as a well known foamer, terpineol in this example.

At the same dosage level of 300 ppm the formulation with terpineol allows to collect more impurities than collector D+E without terpineol, while maintaining calcite losses at a correct level (<3 wt %).

Table 5 lists results obtained with various collectors of general formula (1).

TABLE 5

| | Dosage: | Calcite: | Acid insoluble = |
|---|---|---|---|
| | mg of collector/ | Loss in the | remaining impurity |
| Collector | kg of CaCO₃ | froth (wt %) | amount (wt %) |
| E | 300 | 1.51 | 1.32 |
| K | 300 | 1.79 | 0.84 |
| L | 300 | 2.52 | 1.52 |

Low losses of CaCO₃ are obtained with collectors of general formula (1), especially with collector E and collector K. The best results (lower level of impurities while maintaining low CaCO₃ losses,) are obtained with collector K.

The results of the below Table 6 show that the collector according to the present invention is much more efficient than a conventional collector already known for silicates floatation (collector N), such as an ether diamine: no need for salifying, better purity level, while maintaining CaCO₃ losses at a reasonable level. Moreover the foam obtained with collector N is very liquid, collecting the impurities being thus very difficult to achieve.

TABLE 6

| | Dosage: | Calcite: | Acid insoluble = |
|---|---|---|---|
| | mg of collector/ | Loss in the | remaining impurity |
| Collector | kg of CaCO₃ | froth (wt %) | amount (wt %) |
| 50 wt % D + | 500 | 2.97 | 0.08 |
| 50 wt % E | | | |
| N + acetic acid | 500 | 31 | 0.35 |

Further comparison results are presented in Table 7 below, showing that a collector according to the invention (collector D+collector E) allows for better results than another type of biodegradable collector. Collector 0 is moreover not very foaming, leading to a crust on the top of the froth, which could lead to problem at industrial scale while skimming.

TABLE 7

| | Dosage: | Calcite: | Acid insoluble = |
|---|---|---|---|
| | mg of collector/ | Loss in the | remaining impurity |
| Collector | kg of CaCO₃ | froth (wt %) | amount (wt %) |
| 50 wt % D + | 500 | 2.97 | 0.08 |
| 50 wt % E | | | |
| O | 500 | 2.12 | 0.28 |

The comparative results provided in Table 8 below clearly show that the biodegradable mixture of D and E according to the present invention allows for better results (much lower losses, with better purity) than quaternary ammonium compound according to WO 2007/122148.

TABLE 8

| | Dosage: | Calcite: | Acid insoluble = |
|---|---|---|---|
| | mg of collector/ | Loss in the | remaining impurity |
| Collector | kg of CaCO₃ | froth (wt %) | amount (wt %) |
| P | 500 | 6.38 | 0.36 |
| 50 wt % D + | 500 | 2.97 | 0.08 |
| 50 wt % E | | | |

What is claimed:

1. A collector for the beneficiation by flotation of an aqueous suspension of ores, said collector comprising at least one compound of formula (1): 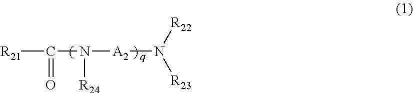
wherein:
R₂₁ represents a hydrocarbon group having from 6 to 30 carbon atoms,
R₂₂ and R₂₃, which are identical or different, each independently represent a hydrocarbon group having from 1 to 6 carbon atoms,
R₂₄ represents hydrogen or a hydrocarbon group having from 1 to 6 carbon atoms,
A₂ represents an alkylene group having from 1 to 6 carbon atoms, and
q is 1, 2, 3 or 4.

2. The collector according to claim 1, wherein the at least one compound of formula (1) has one or more of the following characteristics:
R₂₂ and R₂₃, which are identical or different, each independently represent a hydrocarbon group having from 1 to 4 carbon atoms,
R₂₂ and R₂₃ are identical,
R₂₄ represents hydrogen,
A₂ represents an alkylene group having from 1 to 4 carbon atoms, and
q is 1 or 2.

3. The collector according to claim 1, wherein the at least one compound of formula (1) is chosen from among the condensation products of dimethyl amino propyl amine with a C₁₆-C₁₈ unsaturated fatty acid, the condensation products of dimethyl amino propyl amine with a coco, palm, tallow, and/or oleic fatty acid, and/or with a C₁₂ fatty acid, and/or with a C₁₁ fatty acid, and/or with C₂₀-C₂₂ fatty acid.

4. The collector according to claim 1, further comprising one or more additives chosen from pH-adjusting agents, solvents, depressants, polyelectrolytes, and frothers.

5. The collector according to claim 1, wherein the at least one compound of formula (1) is formulated with one or more other cationic collectors.

6. The collector according to claim 1, further comprising at least one compound of formula (2): 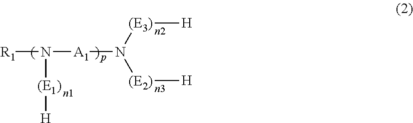
wherein:
R₁ represents a hydrocarbon group having from 6 to 30 carbon atoms,
A₁ represents an alkylene group having from 1 to 6 carbon atoms,
E1, E₂ and E₃, identical or different from each other, are independently chosen from alkylene oxide groups having from 1 to 6 carbon atoms,
n₁, n₂ and n₃, identical or different from each other, and independently from each other, each represent an integer from 1 to 20, and
p is 1, 2, 3 or 4.

7. The collector according to claim 6, wherein n₁, n₂ and n₃, which are identical or different, independently represent an integer from 3 to 20, and wherein the sum n₁+n₂+n₃ ranges form 10 to 40.

8. The collector according to claim 6, wherein n₁, n₂ and n₃, which are identical or different, independently represent an integer which value is from 1 to 10, and wherein the sum n₁+n₂+n₃ is less than 10.

9. The collector according to claim 6, wherein the collector comprises:
at least one compound of formula (1);
optionally at least one compound of formula (2);
optionally at least one other collector; and
optionally one or more additives.

10. The collector according to claim 9, wherein the one or more additives are chosen from pH-adjusting agents, depressants, polyelectrolytes, and frothers.

11. The collector according to claim 6, wherein the collector comprises:
at least one compound of formula (1);
at least one compound of formula (2);
optionally at least one other collector; and
optionally one or more additives.

12. The collector according to claim 11, wherein the one or more additives are chosen from pH-adjusting agents, depressants, polyelectrolytes, and frothers.

13. A method comprising beneficiating an aqueous suspension of ores containing minerals by flotation in a collector, wherein the collector comprises at least one compound of formula (1): 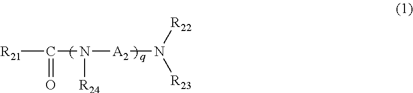
wherein:
R₂₁ represents a hydrocarbon group having from 6 to 30 carbon atoms,
R₂₂ and R₂₃, which are identical or different, each independently represent a hydrocarbon group having from 1 to 6 carbon atoms,
R₂₄ represents hydrogen or a hydrocarbon group having from 1 to 6 carbon atoms,
A₂ represents an alkylene group having from 1 to 6 carbon atoms, and
q is 1, 2, 3 or 4.

14. The method according to claim 13, wherein the ores are chosen from calcium carbonates, magnesium carbonates, phosphates and iron ores.

15. The method according to claim 13, wherein the ores are chosen from limestone, chalk, marble, calcite, calcium carbonate-containing materials, alkaline earth metal containing-calcium carbonates, magnesium carbonates, beryllium carbonates, strontium carbonates, barium carbonates, radium carbonates, lead carbonates, and mixtures thereof.

16. The method according to claim 13, wherein the ores are chosen from wollastonite, barite, titanium oxides, kaolin, kaolinitic clays, calcined kaolinitic clays, montmorillonite, sepiolite, talc, diatomaceous earths, aluminium oxides, aluminium oxides containing other elements, other oxides, sulphates and sulphides, and mixtures thereof.

17. The method according to claim 13, wherein the aluminium oxides containing other elements, other oxides, sulphates, and sulphides are chosen from zinc oxides, zirconium dioxides, tin dioxide, barium sulphate, and zinc sulphide, and mixtures thereof.

18. The method according to claim 13, wherein the ores are chosen from phosphates, potassium chloride, and metal-containing ores, wherein the metal is chosen from iron, platinum, aluminium, nickel, and copper.

19. The method according to claim 13, wherein the total content of the collector is within the range of from 10 ppm to 5000 ppm relative to the amount of ore to be beneficiated.

20. The method according to claim 13, wherein the minerals are chosen from insoluble graphite, iron sulphides, iron oxides, iron hydroxides and iron oxyhydroxides, silica, silicates, clays, mica, potash, and mixtures thereof.

21. The method according to claim 20, wherein the mineral is quartz.

22. Tailings comprising floated impurities, and at least one compound of formula (1): 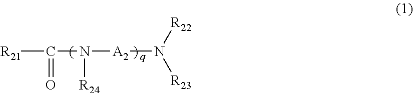
wherein:
R₂₁ represents a hydrocarbon group having from 6 to 30 carbon atoms,
R₂₂ and R₂₃, which are identical or different, each independently represent a hydrocarbon group having from 1 to 6 carbon atoms,
R₂₄ represents hydrogen or a hydrocarbon group having from 1 to 6 carbon atoms,
A₂ represents an alkylene group having from 1 to 6 carbon atoms, and
q is 1, 2, 3 or 4.
